(19) United States
(12) Patent Application Publication
(10) Pub. No.: US 2008/0024019 A1
(43) Pub. Date: Jan. 31, 2008

(54) Motor

(75) Inventors: Masafumi Sakuma, Chiryu-shi (JP); Katsuhiro Tsuchiya, Kariya-shi (JP); Tomohiro Fukushima, Kariya-shi (JP); Akinori Hoshino, Nisshin-shi (JP); Tetsuya Morita, Kariya-shi (JP)

Correspondence Address: BUCHANAN, INGERSOLL & ROONEY PC, POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 11/878,607

(22) Filed: Jul. 25, 2007

(30) Foreign Application Priority Data
Jul. 28, 2006 (JP) 2006-206028

(51) Int. Cl. H02K 5/24; H02K 1/12

(52) U.S. Cl. 310/51; 310/254

(57) ABSTRACT

A motor includes a stator having a stator core wound by a coil and a vibration-absorbing member provided between the coil and the stator core.

### CROSS REFERENCE TO RELATED APPLICATIONS

This application is based on and claims priority under 35 U.S.C §119 with respect to Japanese Patent Application 2006-206028, filed on Jul. 28, 2006, the entire content of which is incorporated herein by reference.

### FIELD OF THE INVENTION

This invention relates to a motor of a power generator, an electric motor or the like.

### BACKGROUND

A known motor has a stator and a rotor. The stator is configured by a stator core around which a coil is wound. The rotor is disposed at an inner circumference or at an outer circumference of the stator having a predetermined space and permanent magnets are embedded in a rotor core of the rotor. In a large size motor such as the one used in a hybrid type vehicle and the like, a large size stator core is used. When the unitary type stator core is used under the circumstances, a material yield may be lowered. Thus, divided cores which are divided at yoke portions, are often employed recently. Also, the stator core and the rotor core are configured by laminating steel sheets.

A known stator is disclosed in JP 2002-084698A. The stator is divided into teeth and teeth are connected to each other at thin-wall connecting portions provided in a core back of a stator core. The connected teeth are laminated spreading along a single straight line and the coil is intensively wound around each teeth after an insulant is inserted thereinto. Then, the connected teeth tiers are bent at the thin-wall connecting portions each serving as a supporting point to configure the stator of an electric motor. In the above-mentioned stator of the electric motor, the insulants inserted into the respective teeth are formed by an insulating material having high mechanical strength. Additionally, a contact surface of a slot opening is provided in each slot opening of the insulant located at a tip end of the slot. The insulants of the adjacent teeth are butted at the contact surfaces when the stator core is bent at the thin wall connecting portions. Improvement in stiffness is achieved by butting the adjacent insulants at each slot opening, and the reduction of vibrations and noises is attempted in a motor thereby.

Another known stator core is disclosed. A plurality of steel bands is formed by a steel sheet and teeth portions and core backs portion are formed at each steel band. The stator core is configured by winding and laminating the steel bands spirally in a way that the teeth portions and the core back portions of each tier and the teeth portions and the core back portions of the adjacent tier are exactly overlapped each other.

It is generally said that a motor having a stator core configured by divided cores causes large vibrations and loud noises. This is due to reduction in stiffness caused by dividing the core. As disclosed in JP 2002-084698, the stiffness is improved by butting the teeth at an inner circumference side of the stator core. However, in order to enable the butting of the divided surfaces of the divided cores and the butting at the inner circumference side simultaneously, it is necessary to improve the dimensional accuracy of the core. Thus, the improvement may lead to a cost increase.

The configuration, in which thin plate members are spirally wound and laminated as described in JP H11-299136A, may be applied to rotor cores. When a rotor core is configured by spirally wounding and laminating the thin plate members, it is necessary to prevent a clearance from being formed between the laminated thin plate members in order to secure centrifugal force resistance. Thus, in order to provide an axial pressuring force for joining the thin plate members together, it is necessary to dispose end plates so as to contact with entire axial end surfaces of the core. In the core configured by winding and laminating the thin plate members spirally, as shown in FIG. 13, lever differences 121p occur in the axial direction at the starting and ending portions of the winding. In order to dispose end plates 123a and 123b in the condition that the axial level differences 121p exist, the end plates 123a and 123b are needed to contact with an entire surface of the rotor core 121. For the reason, it is necessary to provide the precise forms of the end plates 123a and 123b for filling the axial level differences 121p. As a result, the forms of the end plates 123a and 123 become complicated and this leads to degradation of processibility and yield. Also, more tasks are needed in the production process and the cost of the motor increases.

A need exists for a motor which is not susceptible to the drawback mentioned above.

### SUMMARY OF THE INVENTION

According to an aspect of the present invention, a motor includes a stator having a stator core wound by a coil and a vibration-absorbing member provided between the coil and the stator core.

### BRIEF DESCRIPTION OF THE DRAWINGS

The foregoing and additional features and characteristics of the present invention will become more apparent from the following detailed description considered with reference to the accompanying drawings, wherein:

FIG. 1 is a cross section schematically illustrating a structure of a motor according to an embodiment 1 of the present invention;

FIG. 2 is a plain view schematically illustrating a structure of a stator in the motor according to the embodiment 1 of the present invention when viewed from an axial direction;

FIGS. 3A to 3C are views illustrating the structure of the stator in the motor according to the embodiment 1 of the present invention, FIG. 3A is a cross section, FIG. 3B is a plain view viewed from an inner circumference side, and FIG. 3C is a cross section taken along line between III-III′;

FIGS. 4A and 4B are views schematically illustrating a structure of an assembly (excluding a coil) of a stator core and a core holder in the motor according to the embodiment 1 of the present invention, FIG. 4A is a plain view viewed from the axial direction and FIG. 4B is an enlarged cross section taken along line between IV-IV′;

FIG. 5 is an enlarged fragmentary plain view schematically illustrating a structure of the stator core in the motor according to the embodiment 1 of the present invention;

FIG. 6 is a cross section schematically illustrating a structure of a rotor in the motor according to the embodiment 1 of the present invention;

FIG. 7 is a cross section schematically illustrating a structure of a rotor core in the motor according to the embodiment 1 of the present invention when viewed from the axial direction;

FIG. 8 is a fragmentary plain view schematically illustrating the rotor core, which is produced by punching out a plate, in the motor according to the embodiment 1 of the present invention;

FIG. 9 is a fragmentary plain view illustrating the rotor in the motor according to the embodiment 1 of the present invention when viewed from an outer circumferential side of the rotor;

FIG. 10 is a graph showing a result of a radial directional noise measurement when changing the number of motor revolutions;

FIG. 11 is a graph showing a result of a radial directional vibration measurement when changing the number of motor revolutions;

FIGS. 12A to 12C are views illustrating a structure of a stator in a modification of the motor according to the embodiment 1 of the present invention, FIG. 12A is a cross section, FIG. 12B is a plain view viewed from an inner circumferential side, and FIG. 12C is a cross section taken along line between XII-XII′.

FIG. 13 is a fragmentary plain view illustrating a rotor in a motor according to a prior art when viewed from an outer circumferential side; and

FIG. 14A to 14C are views schematically illustrating a structure of a stator in the motor according to the prior art, FIG. 14A is a cross sectional view, FIG. 14B is a plain view viewed from an inner circumferential side, and FIG. 14C is a cross section taken along line between XIV-XIV′.

### DETAILED DESCRIPTION

Embodiments of the present invention will be described below with reference to the attached drawings.

### Embodiment 1

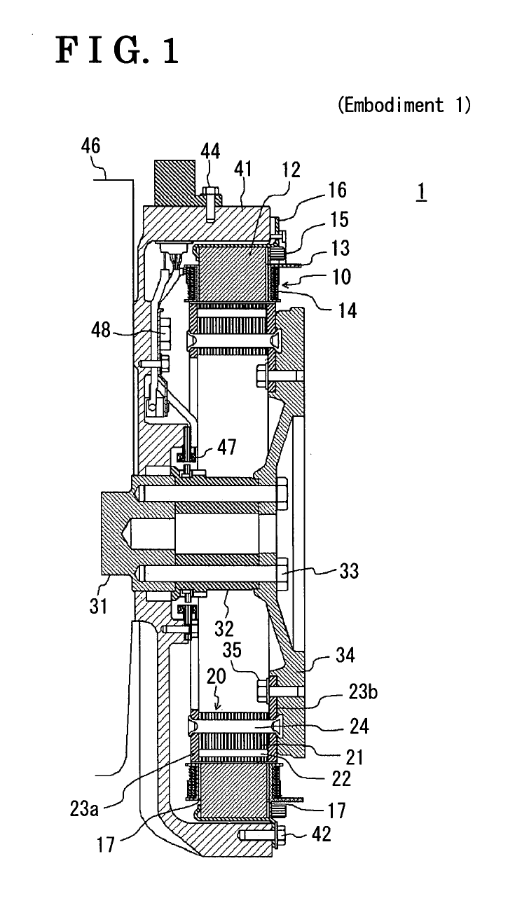

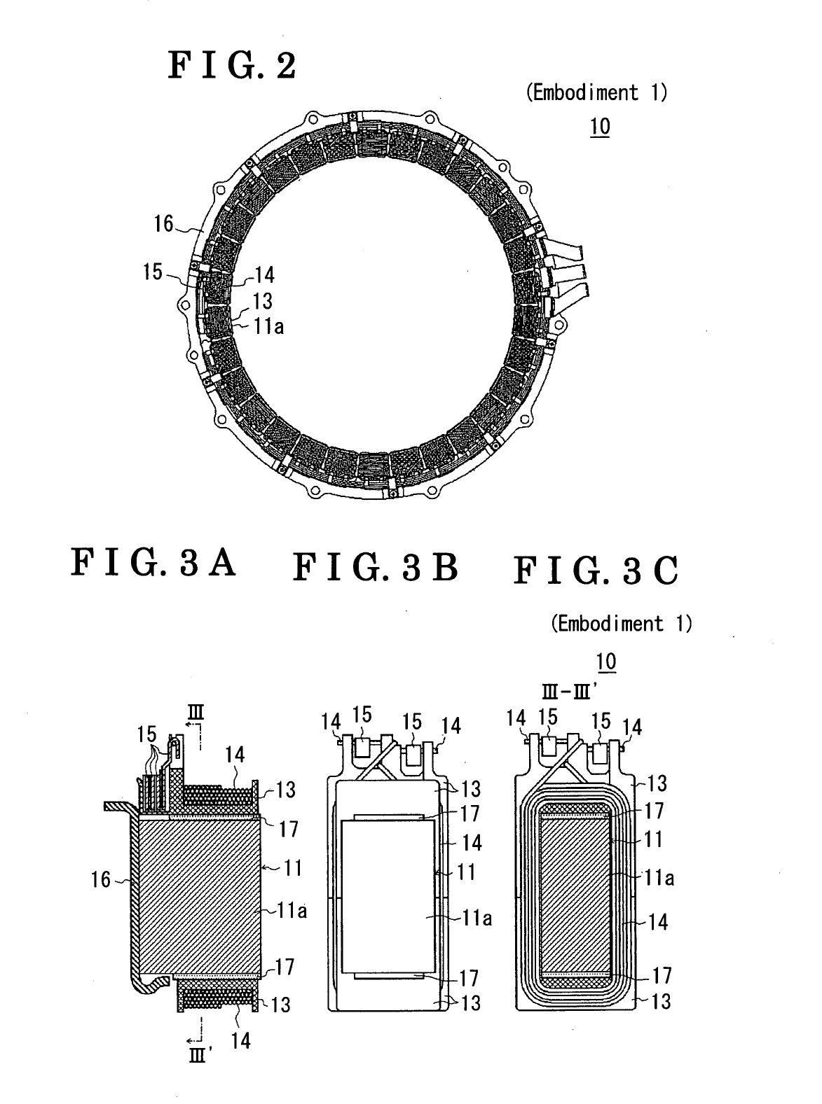

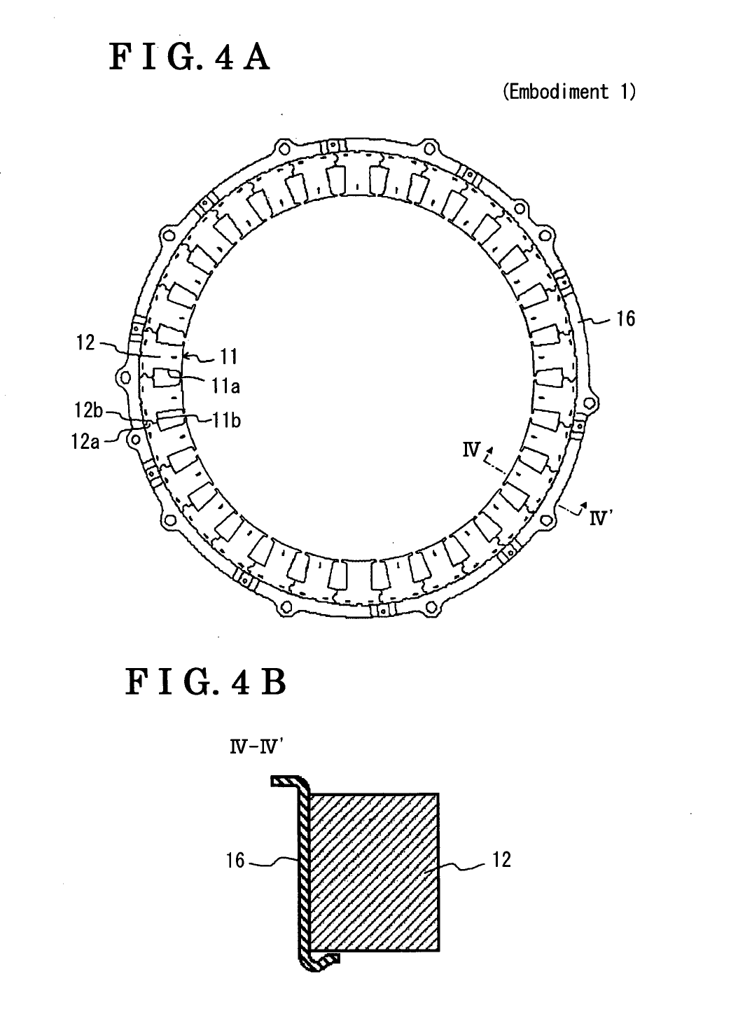

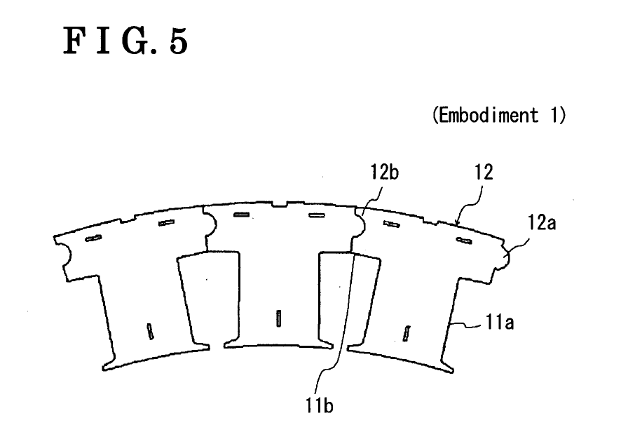

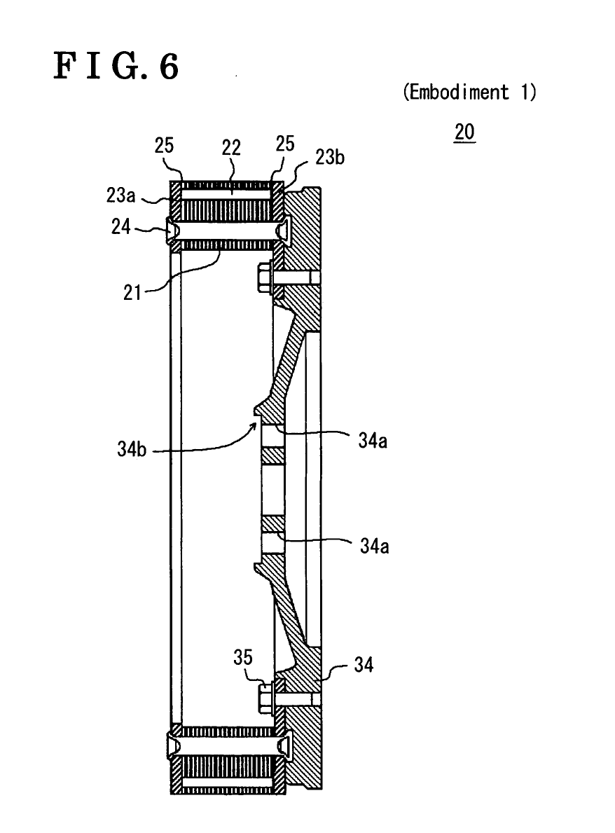

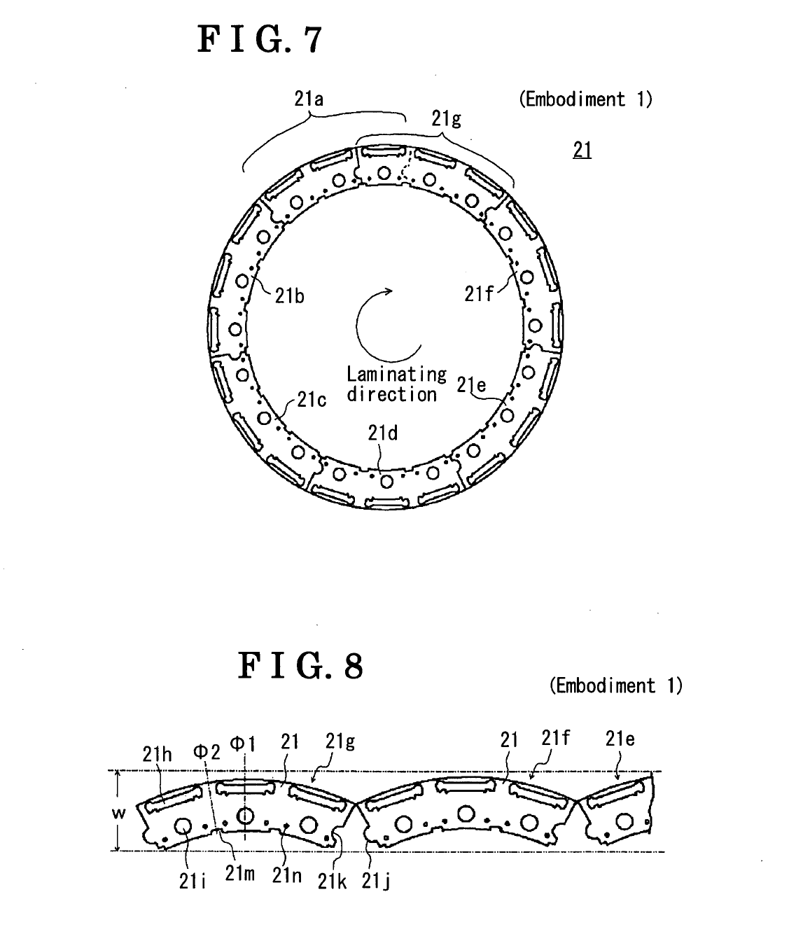

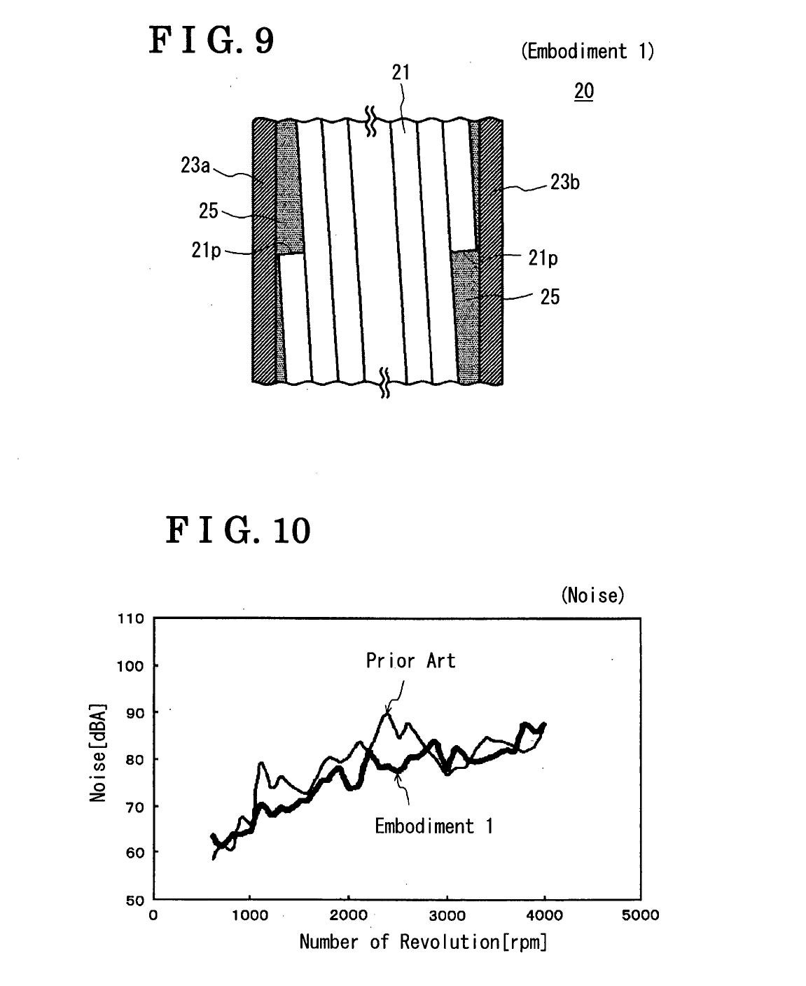

A motor according to an embodiment 1 of the present invention will be described using drawings. FIG. 1 is a cross section schematically illustrating a structure of the motor according to the embodiment 1. FIG. 2 is a plain view schematically illustrating a structure of a stator in the motor according to the embodiment 1 of the present invention when viewed from an axial direction. FIGS. 3A to 3C are views illustrating the structure of the stator in the motor according to the embodiment 1 of the present invention. Specifically, FIG. 3A is a cross section, FIG. 3B is a plain view viewed from an inner circumference of the stator, and FIG. 3C is a cross section taken along line III-III′. FIGS. 4A and 4B are views schematically illustrating a structure of an assembly (excluding a coil and the like) of a stator core and a core holder in the motor according to the embodiment 1 of the present invention. FIG. 4A is a plain view viewed form the axial direction and FIG. 4B is an enlarged sectional view taken along line IV-IV′. FIG. 5 is an enlarged fragmentary plain view schematically illustrating a structure of the stator core in the motor according to the embodiment 1 of the present invention when viewed from the axial direction. FIG. 6 is a cross section schematically illustrating a structure of a rotor in the motor according to the embodiment 1 of the present invention. FIG. 7 is a plain view schematically illustrating a structure of a rotor core in the motor according to the embodiment 1 of the present invention when viewed from the axial direction. FIG. 8 is a fragmentary plain view illustrating the rotor core, which is produced by punching out a steel sheet, in the motor according to the embodiment 1 of the present invention. FIG. 9 is a fragmentary plain view illustrating the rotor of the embodiment 1 of the present invention when viewed from an outer circumference of the rotor.

Referring to FIG. 1, the motor 1 is a brushless type and has the stator 10 and the rotor 20.

The stator 10 is a stator which is generally formed in an annular or a cylindrical shape (refer to FIGS. 1 to 5). The stator 10 has the stator core 11, an insulating member 13, a coil 14, bus rings 15, the core holder 16, and vibration-absorbing members 17 (refer to FIGS. 1 to 4).

A divided core 12 is a component divided into a teeth portion 11a at its yoke portion 11b in a direction that intersects a circumferential direction of the stator core 11. The divided cores 12 are linked so as to form an annular shape and are compressed into the core holder 16 (refer to FIGS. 4 and 5) to form the stator core 11. The position of each divided core 12 may be adjusted by engaging with the adjacent divided cores 12 at a projecting portion 12a and a recessed portion 12b. Each projecting portion 12a and each recessed portion 12b are formed in arc shapes to engage each other in order to secure circularity of an outer circumference of the annular shape formed by linking the divided cores 12. By forming the projecting portions 12a and the recessed portions 12b in the arc shape, a facing dimension between the projecting portion 12a and the recessed portion 12b is increased to reduce the magnetic resistance. Each divided surface of the divided core 12 located at either an inner or an outer circumference side, excluding the projecting portion 12a and the recessed portion 12b, is formed so as to be flat. Each divided core 12 receives radial pressure from the core holder 16 which is disposed at a diamagnetic side, and the pressure allows each divided core 12 to contact each other at divided surfaces in a circumferential direction. Consequently, the divided cores 12 push each other, and thereby the divided cores 12 are fixedly integrated.

The insulating member 13 is a bobbin shaped member which electrically insulates among a coil 14, the stator core 11 and the bus ring 15, and is mounted to the teeth portion 11a of the stator core 11 (refer to FIGS. 1 to 3). The vibration-absorbing member 17 is arranged at each coil end portion between the insulating member 13 and the teeth portion 11a. Here, the coil end portion means a portion arranged at both axial surfaces of the stator core 11.

The vibration-absorbing member 17 absorbs vibrations of the stator core 11 at each coil end portion between the stator core 11 and the coil 14 (refer to FIGS. 1 and 3). The vibration-absorbing member 17 includes a material having a vibration absorption property such as rubber. In FIG. 3, the vibration-absorbing member 17 is arranged at each coil end portion between the stator core 11 and the insulating member 13. However, the position of the vibration-absorbing member 17 is not limited to the coil end portion between the stator core 11 and the insulating member 13 as shown in FIG. 3. As shown in FIG. 12, the vibration-absorbing member 17 may be arranged at each coil end portion between the insulating member 13 and the coil 14. It is desirable that the vibration-absorbing member 17 includes a material having thermal conductivity to facilitate heat dissipation of the coil 14. Further, it is desirable that the vibration-absorbing member 17 includes a material having an electric insulating property to secure the insulation between the coil 14 and the stator core 11. Also, the vibration-absorbing member 17 may be configured by laminating multiple vibration absorption materials and electrical insulation materials, and may be configured by integrally forming the vibration absorption materials and electrical insulation materials with the stator core 11. In FIG. 3, each vibration-absorbing member 17 is arranged between the stator core 11 and the coil 14. However, it is possible to achieve the vibration absorption function by providing a mechanical structure without using the vibration-absorbing members 17. For example, instead of the vibration-absorbing members 17, elastic protruding members which extend from the insulating member 13 are provided on surfaces of the insulating member 13 located at a side of the stator core 11.

The coil 14 is made up of a wire having a dielectric coating on its surface and is structured by winding the wire around an outer circumference of the insulating member 13 mounted to the stator core 11 (refer to FIGS. 1 to 3). The wire is pulled out from both ends of the coil 14 to be connected to the corresponding bus ring 15 electrically and mechanically.

The bus ring 15 is a ring shaped conductive member connected to the coil 14 (refer to FIGS. 1 and 3). The bus rings 15 are disposed at an outer circumferential side of the coil 14 and are mounted to the insulating member 13 in a way that the bus ring 15 is inserted from a motor axis direction. The bus rings 15 are insulated from each other. Each bus ring 15 is electrically connected to a connector (not shown) located at an exterior of a motor cover 41.

The core holder 16 is a ring shaped holder which retains the stator core 11, which is configured by linking the plurality of divided cores 12 to form the annular shape, at the outer circumferential side or at one side of the motor axis direction (refer to FIGS. 1 to 4). The core holder 16 is fixed to the motor cover 41 by way of a bolt 42. The motor cover 41 is fixed to an engine housing 46 by way of a bolt 48. The connector (not shown) is mounted to an exterior of the motor cover 41 by way of a bolt 44.

The rotor 20 is an inner type rotor that is disposed at the inner circumference of the stator 10 having a predetermined distance (Refer to FIG. 1 and FIGS. 6 to 9). The rotor 20 has a rotor core 21, permanent magnets 22, end plates 23a and 23b, fixation pins 24, and a mold resin 25.

The rotor core 21 is a core that is configured by winding and laminating arc shaped unit cores 21a to 21g. The permanent magnet 22 is inserted into each magnet mounting hole 21h formed at the rotor core 21. The end plates 23a and 23b are used for joining tiers of the unit cores 21a to 21g together, and are disposed on both axial sides of the rotor core 21 via the mold resin 25. Each fixation pin 24 is inserted into through holes formed at the end plates 23a and 23b, a through hole formed at the mold resin 25, and a through hole 21i formed at the rotor core 21. Further, the fixation pin 24 integrally fixes the end plates 23a and 23b, the mold resin 25, the permanent magnet 22 and the rotor core 21 by being crimped at both ends thereof. The positions of the tiers of the rotor core 21 are retained by using the fixation pins 24, and thus it is possible to produce the rotor core 21 having excellent centrifugal force resistance.

The mold resin 25 fills a space defined between a surface of the rotor core 21 which has an axial level difference 21p and the facing end plate 23a and also fills another space defined between the other surface of the rotor core 21 which has an axial level difference 21p and the facing end plate 23b. The mold resin 25 is formed by molding. Surfaces of the mold resin 25 which contact with the end plates 23a and 23b are formed so as to lie perpendicular to the axial direction. A circumferential or radial groove or recessed portion may be provided at the surfaces of the mold resin 25 which contact with the end plates 23a and 23b. Further, the mold resin 25 may be injected to fill a space between an inner surface of each magnet mounting holes 21 and the permanent magnet inserted thereinto. In FIG. 6, the mold resin 25 is formed separately from the end plates 23a and 23b, and a wheel member 34. However, depending on the size of the motor, the mold resin 25 may be integrally formed with the end plates 23a and 23b, and the wheel 34 to be fixedly supported to a shaft 32.

The end plate 23b is integrally fixed to the wheel member 34 by way of a plurality of bolts 35. In the wheel member 34, a fitted portion 34b is provided to determine a position of a rotor center. A plurality of mounting holes 34a is provided at the inner circumference side of the fitted portion 34b. The mounting holes 34a are secured to a crankshaft 31 via the shaft 32 by way of the bolts 33.

Next, details of the rotor core 21 will be described below.

The rotor core 21 is designed so as to form n poles in an entire circumference of the rotor 20 of the motor 1 as a rotating machine (n: multiples of 2). In the case shown in FIG. 7, the rotating machine has 20 poles. Each unit core 21a to 21g has 3 poles. Generally, each unit core 21a to 21g has M poles (M: natural numbers excluding factors of n). The unit cores 21a to 21g are formed in a continuous shape by punching out a steel plate formed in a band shape such as a silicon steel band. Thus, in order to narrow the width W of the steel band, it is desirable to have a fewer number of poles in each unit core 21a to 21g.

Connecting portions having an approximately 0.5 to 5 (mm) width are formed between each unit core 21a to 21g and the adjacent unit cores. The width of each connecting potion, 0.5 to 5 (mm), is determined by plate thickness t (mm) of the arc shaped unit cores 21a to 21g, the number of poles M, a diameter of the rotating machine and the like. In many cases, the width is set to approximately 1 to 3 (mm).

In end portions of each unit core 21a to 21g, a projecting portion 21J is formed at one end and a recessed portion 21k is formed at the other end. In the embodiment 1, the projecting portion 21j and the recessed portion 21k are formed in semicircles. When the present invention is implemented, it is desirable to employ the structure of the rotor core 21 in which the unit cores 21a to 21g are combined together spontaneously when the unit cores 21a to 21g are bent at the connecting portions. Thus, it is desirable to form the projecting and recessed portions 21j and 21k in tapered shapes such as a triangle in addition to semicircle. In any case, it is desirable to form the projecting and recessed portions 21j and 21k so as to reduce the magnetic resistance of magnetic paths formed between the adjacent unit cores 21a to 21g or each permanent magnet 22 and the stator.

In each arc shaped unit core 21a to 21g, the number of poles is set to M, and M magnet mounting holes 21h are formed in the arc shaped unit cores 21a to 21g. Through holes 21i are formed for mounting fixation pins 24 corresponding to the magnet mounting holes 21h. More specifically, each through hole 21i is formed at a position φ1 shown in FIG. 8 lying on a line extending from a center of a circle formed by the unit cores 21a to 21g to a substantial center of the corresponding magnet mounting hole 21h in a radial direction. The position of the through hole 21i should be as far away from the magnet mounting hole 21h as possible, and the through hole 21i should be formed so as to allow the unit cores 21a to 21g to obtain the mechanical strength.

In each arc shaped unit core 21a to 21g, notch recessed portions 21m are formed at an opposite side of the stator 10 for taking up the unit cores 21a to 21g. The notch recessed portions 21m are used for drawing in and sequentially assembling the tiers of the unit cores 21a to 21g which are formed in a band shape when the unit cores 21a to 21g are wound and laminated. Each notch recessed portion 21m is formed at a proper position so that strength of a vicinity of the through hole 21i, which receives a centrifugal force caused by rotations acting on the unit cores 21a to 21g, is not affected by formation of the notch recessed portion 21m. For example, the notch recessed portion 21m may be formed a position φ2 shown in FIG. 8 lying on a line extending from a center of a circle formed by the unit cores 21a to 21g to a center between each unit core and the adjacent unit core in a radial direction.

The tiers of the arc shaped unit cores 21a to 21g which are configured as described above are assembled as follows. A tip end of a first tier of the arc shaped unit cores 21a to 21g is fixed to an end of a cage-like rotary frame (not shown), which is engaged with the notch recessed portions 21m, by way of a magnet or the like. At this time, the axial moving amount of the lamination winding X is set: X=θ·t/360 (θ: the angle at which tiers are wound, t: thickness of the unit cores).

When the tiers of the unit cores 21a to 21g are laminated in the axial direction of the lamination winding at any designated number of time in a manner described above, (as shown in FIG. 7, the lamination is carried out by rotating the cage like rotary frame (not shown) to the right in the embodiment 1.), the first unit core 21a and the unit core 21g are overlapped by a third of each unit core. This overlapping causes phase shift every time the tier of the rotor core 21 is laminated. That is, the overlapped position of the arc shaped unit cores 21a to 21g is shifted every time the lamination is carried out and the rotor core lamination is formed in a zigzags pattern.

Since the rotating machine has n poles (n: multiples of 2) and the number of poles of each unit core 21a to 21g is set to M which is any one of natural numbers excluding the factors of n, the zigzag lamination is formed. As described above, once the axial moving amount of the lamination winding X of the unit cores 21a to 21g reaches a specific value, the lamination is completed. It is desirable that an ending position of the lamination winding comes at a position which contacts with the tip end portion of the first tier of the arc shaped unit cores 21a to 21g for balancing the entire shape of the rotor 20.

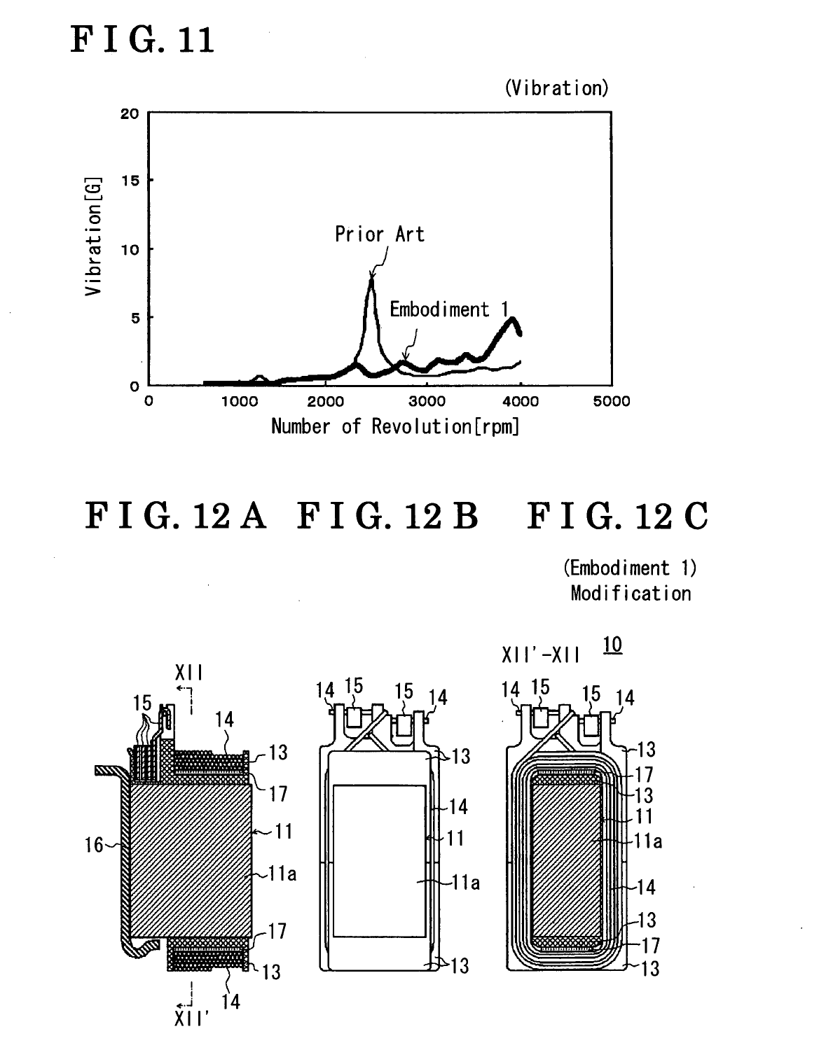

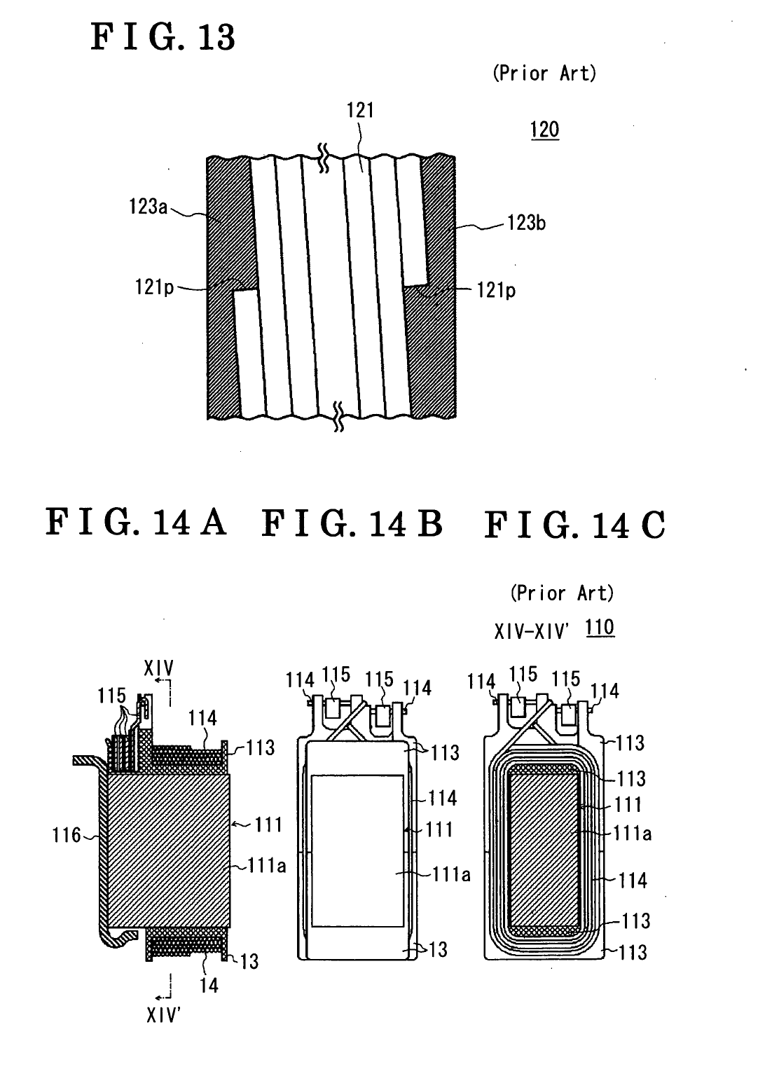

Next, the result of the noise and vibration measurement will be described. In the measurement, the motors using the stator according to the prior art and using the stator according to the embodiment 1 are used and the number of motor revolutions is changed. FIG. 10 is a graph showing the result of the radial noise measurement when the number of motor revolutions is changed. FIG. 11 is a graph showing the result of the radial vibration measurement when the number of motor revolutions is changed. The stator according to the prior art (refer to FIG. 14) has a stator core comprised of divided cores and does not include the vibration-absorbing members 17 which are used in the stator (refer to FIG. 3) according to the embodiment 1.

The motor using the stator according to the embodiment 1 (refer to FIG. 3) has no peak, which is observed as a resonance point, at the motor revolution of 1000 to 3000 rpm that is commonly used. The vibrations and noises are significantly reduced compared to the motor using the stator according to the prior art (refer to FIG. 14).

Here, the fluctuations of an attractive force acting between the rotor and the stator occurs due to electrification or rotor rotations, and vibrations occur in the stator core. In particular, when the stator core is supported to a case by way of a core holder 116 which is shown in FIG. 14 at one side, the vibrations using the fixed point of the stator core as a supporting point, i.e. the vibrations having an axial (a vertical direction of FIG. 14) component occur in the stator core 11. One of measures for damping such vibrations is improvement in stiffness of each component. As observed in the stator according to the prior art (refer to FIG. 14), a coil 114 is tightly wounded around each divided core via an insulating member 113 in a motor having a stator core 111 configured by the divided cores. In addition, in order to increase the coil space factor of the coil 114, the coil 114 is wound with high tension. Consequently, the stator core 111 and the coil 114 are substantially integrated. Further, in the stator according to the prior art (refer to FIG. 14), the divided cores are retained and integrated so as to secure the mechanical strength. As a result, the stator according to the prior art obtains high stiffness. In this condition, if the vibrations occur in the stator core 111 in response to the fluctuations of the attractive force acting on the stator core 111, a stator 110 integrated with high stiffness causes resonance movements. Thus, a big noise occurs. Also, the stator according to the prior art (refer to FIG. 14) is formed to have high stiffness, and thus complicating the assembly and increasing weight and cost. On the other hand, in the stator according to the embodiment 1 (refer to FIG. 3), the vibration-absorbing members 17 are provided at the coil end portions, and thus it is possible to effectively damp the axial vibrations without deteriorating the coil space factor. Furthermore, in the stator according to the embodiment 1 (refer to FIG. 3), the improvement in stiffness of the structural components is not needed, and thus it is possible to reduce the size.

According to the embodiment 1, it is possible to reduce the noise of the motor. Because the vibrations of the stator core 11 are quickly damped by the vibration-absorbing members 17 located between the coil and the cores. Thus, the vibrations of the stator core 11 are rather inhibited.

Further, the output of the motor is improved and it is possible to achieve the reductions in size, weight, and cost. Since it is possible to reduce the vibrations and the noises by the vibration-absorbing members 17, the improvement of the stiffness of the structural components is not needed. Thus, it is possible to achieve the reductions in the size and the weight. Also, it is possible to improve the thermal conductivity with the vibration-absorbing members 17, and thus the heat dissipation of the coil 14 is facilitated. Consequently, it is possible to increase the making current and the coil current density. Therefore, it is possible to improve the output and to reduce the size and the weight.

Furthermore, it is possible to obtain an inexpensive motor. Level differences 21p located on the both axial end surfaces of the rotor core 21 are filled by the mold resin 25, and thus it is possible to simplify the forms of the end plates 23a and 23b. Therefore, the production cost is reduced.

Also, the functions of the conventional components are achieved by the mold resin, and thus the number of components is reduced. Consequently, it is possible to reduce the cost for the structural components.

Still further, the mold resin 25 is injected into each magnet mounting hole 21h to fill the spaces between the inner surface of the magnet mounting hole 21h and the permanent magnet 22 disposed thereinto, and it is possible to fix the permanent magnet 22 thereby.

Still further, the rotor core 21 is configured by laminating and winding the arc shaped unit cores 21a to 21g, and thus material yield is improved compared to when producing a unitary annular rotor core.

Still further, the axial moving amount of the winding of the unit cores 21a to 21g is set to X=θ·t/360 (θ: the angle at which tiers are wound, t: thickness of the unit cores), and thus the axial moving amount of the winding of the unit cores 21a to 21g is equalized on the entire circumference. As a result, it is possible to minimize the misalignment due to the axial lamination such as the misalignments of the magnet mounting hole 21h, the through hole 21i and the like.

In the embodiment 1, the configuration of the stator 10 and the rotor 20 of the motor 1, which is an inner rotor type motor, is described. However, it is possible to apply the configuration to an outer rotor type motor. Also, in FIGS. 1 to 9, a motor used in a hybrid car is described as an example. However, the use of the motor is not limited to the example.

In the viewpoint of the present invention, the motor having the stator, which is configured by winding the coil 14 around the stator core 11, is characterized in that the vibration-absorption members 17 are provided between the coil 14 and the stator core 11.

According to the structure of the present invention, it is possible to reduce the noises caused by the motor 1. Because the vibrations of the stator core 11 are damped quickly by the vibration-absorption function located between the coil 14 and the stator core 11, and thus the vibrations of the stator 10 are rather inhibited.

The principles, of the preferred embodiments and mode of operation of the present invention have been described in the foregoing specification. However, the invention, which is intended to be protected, is not to be construed as limited to the particular embodiment disclosed. Further, the embodiment described herein are to be regarded as illustrative rather than restrictive. Variations and changes may be made by others, and equivalents employed, without departing from the spirit of the present invention. Accordingly, it is expressly intended that all such variations, changes and equivalents that fall within the spirit and scope of the present invention as defined in the claims, be embraced thereby.

1. A motor comprising:
a stator having a stator core wound by a coil; and
a vibration-absorbing member provided between the coil and the stator core.

2. A motor according to claim 1, further comprising:
an insulating member disposed between the coil and the stator core, wherein the vibration-absorbing member is provided between the stator core and the insulating member.

3. A motor according to claim 1, further comprising:
an insulating member disposed between the coil and the stator core, wherein the vibration-absorbing member is provided between the coil and the insulating member.

4. A motor according to claim 1, wherein the vibration-absorbing member is provided in a quantity of two arranged at coil end portions between the coil and the stator core and at both axial surfaces of the stator core.

5. A motor according to claim 2, wherein the vibration-absorbing member is provided in a quantity of two arranged at coil end portions between the coil and the stator core and at both axial surfaces of the stator core.

6. A motor according to claim 3, wherein the vibration-absorbing member is provided in a quantity of two arranged at coil end portions between the coil and the stator core and at both axial surfaces of the stator core.

7. A motor according to claim 1, further comprising:
divided cores each having a yoke portion extending in a direction that intersects a circumferential direction of the stator core,
wherein the divided cores are linked via the yoke portions so as to form the stator core.

8. A motor according to claim 2, further comprising:
divided cores each having a yoke portion extending in a direction that intersects a circumferential direction of the stator core,
wherein the divided cores are linked via the yoke portions so as to form the stator core.

9. A motor according to claim 3, further comprising:
divided cores each having a yoke portion extending in a direction that intersects a circumferential direction of the stator core,
wherein the divided cores are linked via the yoke portions so as to form the stator core.

10. A motor according to claim 4, further comprising:
divided cores each having a yoke portion extending in a direction that intersects a circumferential direction of the stator core,
wherein the divided cores are linked via the yoke portions so as to form the stator core.

11. A motor according to claim 5, further comprising:
divided cores each having a yoke portion extending in a direction that intersects a circumferential direction of the stator core,
wherein the divided cores are linked via the yoke portions so as to form the stator core.

12. A motor according to claim 6, further comprising:
divided cores each having a yoke portion extending in a direction that intersects a circumferential direction of the stator core,
wherein the divided cores are linked via the yoke portions so as to form the stator core.
